(19) United States
(12) Patent Application Publication
(10) Pub. No.: US 2016/0232767 A1
(43) Pub. Date: Aug. 11, 2016

(54) ONE-TIME-USE TAG WITH OPTICAL CODE

(71) Applicant: Xiao Hui Yang, Saratoga, CA (US)

(72) Inventor: Xiao Hui Yang, Saratoga, CA (US)

(21) Appl. No.: 15/098,692

(22) Filed: Apr. 14, 2016

Related U.S. Application Data
(63) Continuation-in-part of application No. 14/606,351, filed on Jan. 27, 2015, now Pat. No. 9,324,221.
Application No. 14/606,351 is a continuation-in-part of application No. 14/099,788, filed on Dec. 6, 2013, now Pat. No. 9,355,539.
Application No. 14/099,788 is a continuation-in-part of application No. 14/184,786, filed on Feb. 20, 2014.
(60) Provisional application No. 61/734,478, filed on Dec. 7, 2012.
(60) Provisional application No. 61/767,147, filed on Feb. 20, 2013.

(51) Int. Cl. G08B 13/24

(52) U.S. Cl. CPC G08B 13/2434

(57) ABSTRACT

Embodiments of the current invention entail a highly visible tag that is attached to products at a highly visible locations. It can easily be removed once purchasers buy the product. To remove it, purchasers must destroy the tag to use the product in public, and it cannot be reattached by the purchaser. Absence of a tag makes it clear that the buyer has removed the tag and provides an indication that the product has been used. A retailer's policies determines how an attempt to return a tagless product is handled. The tag is most effective for products that are used in public. The tag has an optical code to prevent a counterfeit tag from being attached to the product in order to return it, when it has been used by the purchaser. The optical code may be alphanumeric or machine readable. The tag may carry EAS technology.

### CROSS REFERENCE TO RELATED APPLICATIONS

This application is a continuation-in-part application of U.S. patent applications Ser. No. 14/099,788, filed on Dec. 6, 2013, Ser. No. 14/184,786, filed on Feb. 20, 2014, and Ser. No. 14/606,351, filed on Jan. 29, 2015. U.S. patent application Ser. No. 14/099,788 published as U.S. 2014/0159902 A1 and claims priority to U.S. Provisional Application 61/734,478, filed on Dec. 7, 2012. U.S. patent application Ser. No. 14/184,786 published as U.S. 2014/0232545 A1 and claims priority to U.S. Provisional Application 61/767,147, filed on Jan. 20, 2013. U.S. patent application Ser. No. 14/606,351 is itself a continuation-in-part of U.S. application Ser. No. 14/099,788. The entirety of U.S. application Ser. Nos. 14/099,788, 14/184,786, and 14/606,351, and U.S. Provisional Applications 61/734,478, and 61/767,147, including both the figures and specifications are incorporated herein by reference.

### FIELD OF THE INVENTION

This invention relates to the prevention of the fraudulent return of purchased goods. More specifically, this invention relates to the prevention of the return of garments which have been purchased, worn, and then returned to the store after having been worn, or the return of a lesser valued good on the purchase receipt of a greater valued good.

### BACKGROUND OF THE INVENTION

Theft of goods in the retail environment is a serious concern. Theft cuts into the margins of a business making it more difficult for a business to compete and succeed. One type of theft is fraudulently returned garments. This type of theft involves purchasing a garment, perhaps a more expensive high end garment, and wearing it at least once. After the garment has been worn, it is fraudulently returned to the retail outlet where it was purchased. This allows the purchaser to get the benefit of the product without paying for it. This frequently occurs when a person purchases a more expensive article of clothing for a particular occasion, wears the garment, and then returns it. This technique of theft is sometimes called wardrobing in the retail industry.

One measure that is employed against this type of theft employs a highly visible anti-wardrobing tag placed on the garment. The tag is placed in a highly visible location so that the garment cannot be worn without the tag being seen. Once a garment is bought, the tag can be removed by a purchaser, but with the removal of the tag, the garment may not be returned, or can only be returned with a mark-down from purchase price, or other return policies may be applied.

In response to the deployment of anti-wardrobing tags, additional theft techniques have been developed and encountered in the retail sales environment. One technique employed to counter anti-wardrobing tags is the counterfeiting of the anti-wardrobing tags. Since they are disposable, anti-wardrobing tags are very simple devices and do not have distinguishing characteristics to identify individual tags, or to identify a tag with a specific item, or garment. Because of this, if a reasonably similar tag is substituted for a removed anti-wardrobing tag, the garment may be accepted in a return transaction when the garment has actually been worn.

Another theft technique is the unequal exchange of garments. In this technique, two garments are acquired by a thief, one garment being much more expensive than the other. The thief then returns the less expensive garment with the sales receipt for the more expensive garment. The thief then gets the difference in cost between the two garments. This technique also requires a counterfeit anti-wardrobing tag to be placed on the returned garment in order for the garment to be accepted.

There remains a need for a means of identifying individual anti-wardrobing tags to defeat counterfeit tags. This means of identification needs to be as inexpensive as the tags themselves. It also needs to be flexible to adapt to different retailers and different retail situations.

### SUMMARY FOR EMBODIMENTS OF THE INVENTION

Embodiments of the current invention entail a highly visible tag that can be attached to the garment at the store, but can easily be removed once the purchaser buys the garment and takes it home. Once the purchaser gets the garment home, they can remove it themselves and wear it. Once the tag is removed, it can not be reattached by the consumer. Depending on the store policy, the garment may not be returned, or there may be an extra fee for returning the garment, or other similar policies. The use of a tag makes it clear that the buyer has removed the tag and provides an indication that the garment has been worn in public.

Each tag has an optical code, or identifier, located on it. This optical code may be clearly visible or it may be hidden from being viewed in the normal course of activity. The optical code may be a unique identifier unique to each tag, it may be a group identifier, i.e., it may identify the lot from which the tag originated, or the optical code may be a chronological indicator and reflect a date/time.

In at least one embodiment, the optical code is an alphanumeric code visible on the exterior of the tag. In other embodiments, the optical code is a machine readable code such as a bar code, a two dimensional code, or other similar code. One type of commonly known two dimensional code is a QR code. In some embodiments, the optical code is on the exterior of the tag but only visible when exposed to light produced by an ultraviolet, or black light, bulb. Embodiments having optical codes that are only visible in an ultraviolet light environment may achieve this effect with ultraviolet light reactive ink, or ultraviolet light reactive plastic.

In at least one embodiment the tag consists of an elongated plastic piece having a head and a lanyard extending from the head. The head has a relatively large flat face and a hub extending from behind the face. The face provides a large surface for a logo, an optical code, and/or a statement about removal of the tag, etc. The hub tapers as it extends away from the face and is sized to be pressed through an aperture on garment such as a buttonhole. The hub has an aperture through it generally aligned with the lanyard and sized to accept the insertion of the lanyard. The lanyard also presents a suitable surface for locating an optical code.

The lanyard has several cleats along its length. When the free end of the lanyard is passed through the aperture in the hub and pulled, these cleats pass through the aperture as well and prevent the lanyard from being pulled back out of the aperture in the hub. A short distance along its length from the head, the lanyard has a tab and break lines formed along each side of the tab across the width of the lanyard. This tab and the break lines to each side of it facilitate the parting of the lanyard into sections. Pulling the tab parts the lanyard into a stub section still attached to the head and a tail section passing through the aperture. The tab section itself may also become separated from both of the other sections of lanyard. Once the lanyard is separated, the tag may pressed out of the aperture to allow the garment to be worn. If necessary the tail section of the lanyard may be pull the rest of the way through the aperture in the hub of the head of the tag.

In some embodiments of the tag, the head will enclose an EAS device. The EAS device would interact with a larger EAS system to provide security and tracking functions. Due to size and cost factors, the EAS device would most likely be passive, but active EAS devices would also be possible. In some cases, the EAS device may actually be a dummy device which produces a rattle within the body of the tag to deceive would be thieves that an EAS device is housed in the tag. Of course, in the latter case the dummy device would not interact with the larger EAS system.

In another embodiment, the tag consists of an elongated plastic piece having a hinge in the middle so that it can fold over. Toward one end of the unfolded tag is a post, and at the other end, coincident with the post when the tag is folded, is an aperture through the tag. At least one flexible tab extends laterally from the post. When the tag is folded, the post inserts through the aperture. The flexible tab is located at a height on the post such that, when the post is inserted through the aperture, it is bent and passes through the aperture. After the tab is forced through the aperture, it springs back to its extended position and acts to keep the tag in its folded configuration. Once the tag is folded and attached to an article of clothing, the exterior of the folded tag presents broad smooth surfaces for locating optical codes.

In one embodiment, a tack is located between the post and its respective end and it is located on the same side and directed in the same direction as the post. At the opposite end of the unfolded tag, an aperture is located to coincide with the tack when the tag is closed. When the tag is closed over a piece of cloth, i.e. a garment, the tack passes through the garment and inserts into the aperture. The aperture may be formed by a raised rim on that side of the tag. The relative positions of the tack and aperture may be reversed.

Generally, each half of the folded tag has a rim around its edge that matches and presses against the rim of the other half when the tag is folded. However, in the area of the tack and aperture, the rim is not present. This leaves a gap that accommodates the cloth of a garment when the tag is installed on a garment.

To remove a tag from a garment or other item, the end of the tag where the post is located is squeezed. This pushes the post even further through the aperture, so that the body of the post beneath the flexible tab is exposed outside the tag. The post can then be cut beneath the flexible tab to remove the flexible tab, which is what normally retains the tag in a folded configuration. In use, the tag would be removed by the purchaser of the garment when the purchaser wears the garment in public.

In at least one embodiment the hinge between the two portions of the body of the tag is a compound hinge. The hinge folds at its middle and also where it attaches to the two portions of the body. This allows the hinge to fold into the interior of the body of the tag when the tag is in the folded configuration, and prevents access to the hinge by any who may want to tamper with the tag.

Some embodiments of the tag will enclose an EAS device. The EAS device would interact with a larger EAS system to provide security and tracking functions. The EAS device may range from passive, to semi-passive, to active. In some cases, the EAS device may actually be a dummy device which produces a rattle with the body of the tag to deceive would be thieves that an EAS device is housed in the tag. Of course, in the latter case the dummy device would not interact with the larger EAS system.

In another embodiment of a folding tag employing a tack to maintain the tag, it is the body of the tag that is the destructible element. In proximity to the tack is a first element for holding the tag in a folded position, and in proximity to the aperture of the tack is a second element for holding the tag in a folded position. These two elements engage each other when the tag is folded and keep the tag in the folded state. This keeps the tack inserted through the aperture and garment.

In some embodiments, the tag has a medallion, or seal, attached to the body of the tag and there is a continuous series of perforations through the body of the tag in proximity to the medallion. The medallion has an exposed edge which presents a tab for grasping. In embodiments having the medallion and perforations, one way to remove the tag from the garment is to part the tag at the perforations. A buyer turns or pulls the exposed edge (tab) of the medallion and tears the body of the tag into multiple pieces along the lines of the perforations in the tag. Once the body of the tag is torn in this fashion the holding elements can be disengaged with ease and the tag removed from the garment without damaging the garment. The face of the medallion, provides a large surface for an optical code, and/or a statement about removal of the tag, etc, and/or a logo, or seal.

In some embodiments of this latter embodiment of folding tag, the first holding element, the second holding element or both, have a continuous series of perforations around them where they join the body of the tag. To remove the tag, a buyer pulls the two ends of the tag apart, tearing the perforations around a holding element and parting the tag. When the perforations around a holding element tear, the holding elements can remain joined, while the two ends of the tag separate. With the separation of the ends of the tag, the tack is withdrawn from the slot and the garment, and the tag can be removed from the garment.

### BRIEF DESCRIPTION OF THE DRAWINGS

Additional utility and features of the invention will become more fully apparent to those skilled in the art by reference to the following drawings, which illustrate some of the primary features of preferred embodiments.

FIG. 1 is a top perspective view of an embodiment of a tag having an anti-counterfeiting optical code before application to an object with the tag having a lanyard.

FIG. 2 is a bottom perspective view of an embodiment of a tag having an anti-counterfeiting optical code before application to an object with the tag having a lanyard.

FIG. 3 is a front perspective view of an embodiment of a tag having an anti-counterfeiting optical code with the tag being attached to an object by a lanyard.

FIG. 4 is a back perspective view of an embodiment of a tag having an anti-counterfeiting optical code with the tag being attached to an object with a lanyard.

FIG. 5 is a perspective view of an embodiment of a hinged tag having an anti-counterfeiting optical code, the tag being in an opened configuration.

FIG. 6 is a perspective view of an embodiment of a hinged tag having an anti-counterfeiting optical code, the tag being in a closed configuration, showing the post inserted through the aperture and the flexible tabs external to the tag.

FIG. 7 is a perspective view of the embodiment of the hinged tag of FIG. 6 in a closed configuration showing the post trimmed and the flexible tabs removed.

FIG. 8 is a perspective view of the embodiment of the hinged tag of FIG. 5 in an opened configuration, showing the post trimmed and the catch tabs removed.

FIG. 9 is a bottom perspective view of an embodiment of a hinged tag having an anti-counterfeiting optical code, the tag being in an opened configuration.

FIG. 10 is a top perspective view of the embodiment of a hinged tag of FIG. 9 in an opened configuration.

FIG. 11 is a top perspective view of the embodiment of a hinged tag of FIG. 9 in a closed configuration.

### DETAILED DESCRIPTION OF EMBODIMENTS

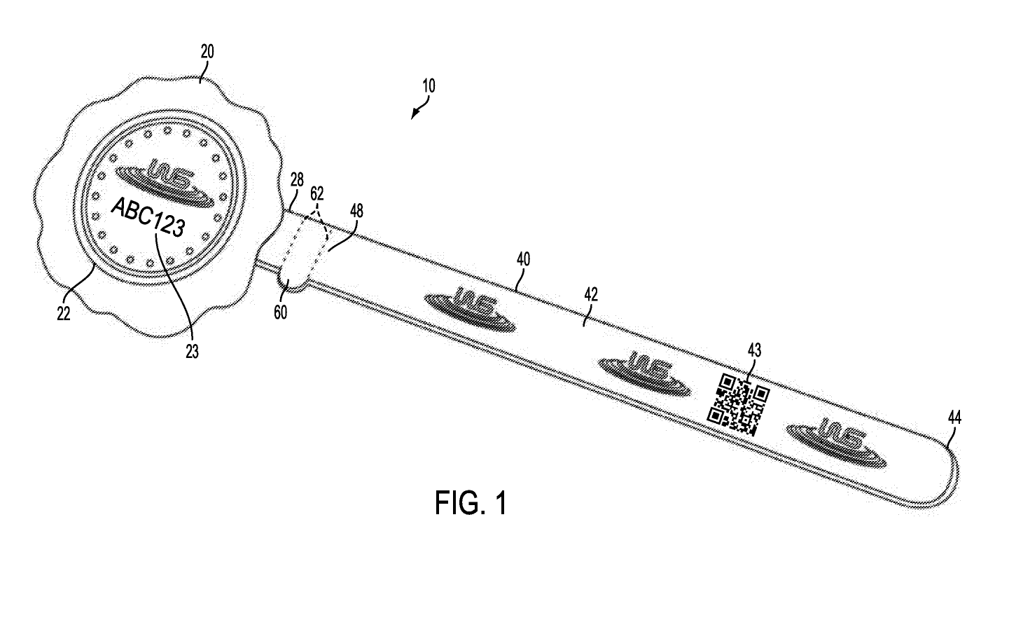

FIG. 1 is a top perspective view of an embodiment of one-time-use tag 10 before application to an object. Tag 10 has a head 20 with lanyard 40 extending from it. Head 20 in the embodiment shown in FIG. 1 is round and has a large face appearing like a seal 22. Seal face 22 is large enough to allow a cosmetic logo to be applied to it.

Additionally, optical code 23 may be located on seal face 22. While FIG. 1 shows optical code 23 sharing seal face 22 with a logo, optical code 23 could be alone on seal face 22. Optical code 23 may be an alphanumeric code as shown in FIG. 1, or it may be a machine readable code such as a bar code or a two dimensional code. Among other functions, optical code 23 serves to defeat the replacement of a removed single-use tag with a counterfeit tag. Although a thief may be able to obtain a counterfeit tag that sufficiently approximates a retailer's one-time-use tag, without the correct optical code, the replacement tag will not pass closer inspection.

Lanyard 40 extends from head 20 and is comprised of three parts. These three parts are stub 28 which attaches to head 20 and extends from it, tab 60 and tail 42. Stub 28 is relatively short and extends a short way from head 20. Tab 60 is attached to the end of stub 28 and tail 42 of lanyard 40 is attached to tab 60. Where tab 60 attaches to stub 28 and tail 42 of lanyard 40, two break lines 62 run across the width of lanyard 40. As will be discussed later, these break lines 62 assist in the separation of the sections of lanyard 40, making tag 10 a one-time-use tag. Like optical code 23, optical code 43 on lanyard 40 of tag 10 defeats the use of counterfeit tags. Optical code 43 may be a machine readable code such as a bar code or two dimensional code as shown in FIG. 1, or it may be an alphanumeric code.

Optical code 23 and optical code 43 may be normally visible, or they may require application of ultraviolet light to make optical codes 23 and 43 visible. Optical codes 23 and 43 may be a unique identifier for one-time-use tag 10 or it may be a group identifier, i.e. be a lot identifier for tag 10. Optical codes 23 and 43 may be placed on one-time-use tag 10 by several methods, including printing, transfer stamping, hot stamping, foil stamping, plastic welding, engraving, laser marking, or pin stamping. Ultraviolet light reactive ink, paint, and plastics are available for applications in which optical codes 23 and 43 are used in conjunction with ultraviolet light to create a normally invisible code. It is not necessary that both optical code 23 and optical code 43 be used on a tag. The presence of both in the figures is only for illustration of options.

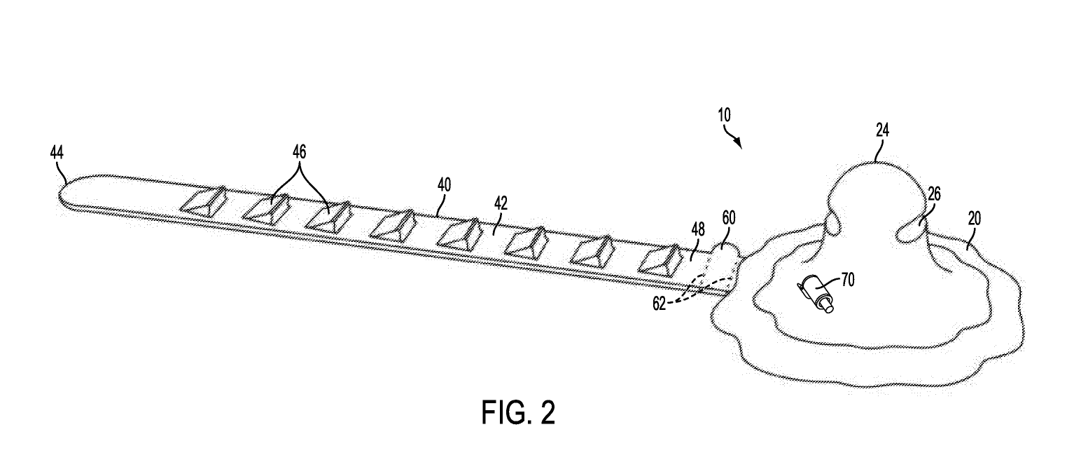

FIG. 2 is a bottom perspective view of the embodiment of tag 10 shown in FIG. 1 before application to an object. In FIG. 2, hub 24 extends upward from the back of head 20 of tag 10. Aperture 26 passes through hub 24 and is generally aligned with lanyard 40. Hub 24 is intended to pass through an aperture in a garment, such as a button hole or similar aperture. Lanyard 40 with its three sections is also visible in FIG. 2. Cleats 46 are located on the back side of tail 42 of lanyard 40. Several cleats 46 are spaced at regular intervals and run for a good section of tail 42. Tail 42 terminates in free end 44 of lanyard 40. To install tag 10 on an object hub 24 of head 20 is pressed through a button hole, or other aperture, in the object and free end 44 of lanyard 40 is passed through aperture 26 in hub 24. As free end 44 is pulled, more of tail 42 passes through aperture 26. As tail 42 passes through aperture 26, cleats 46 pass through aperture 26 and prevent tail 42 from being removed from aperture 26. This keeps tag 10 in location on the object being protected.

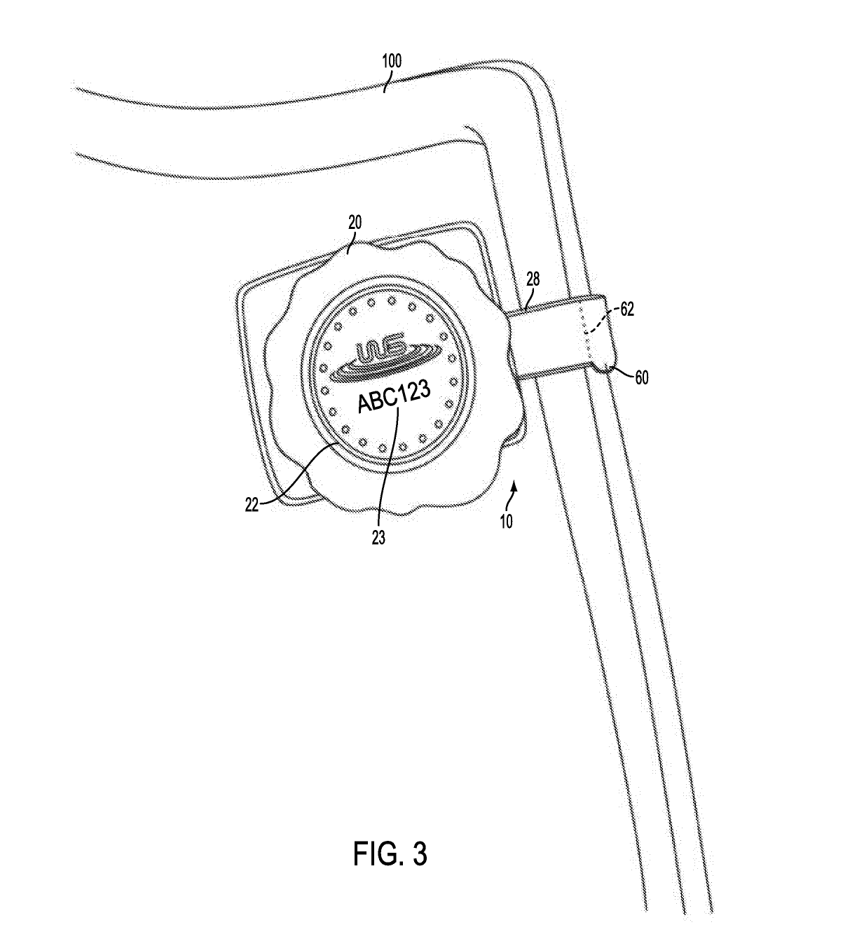

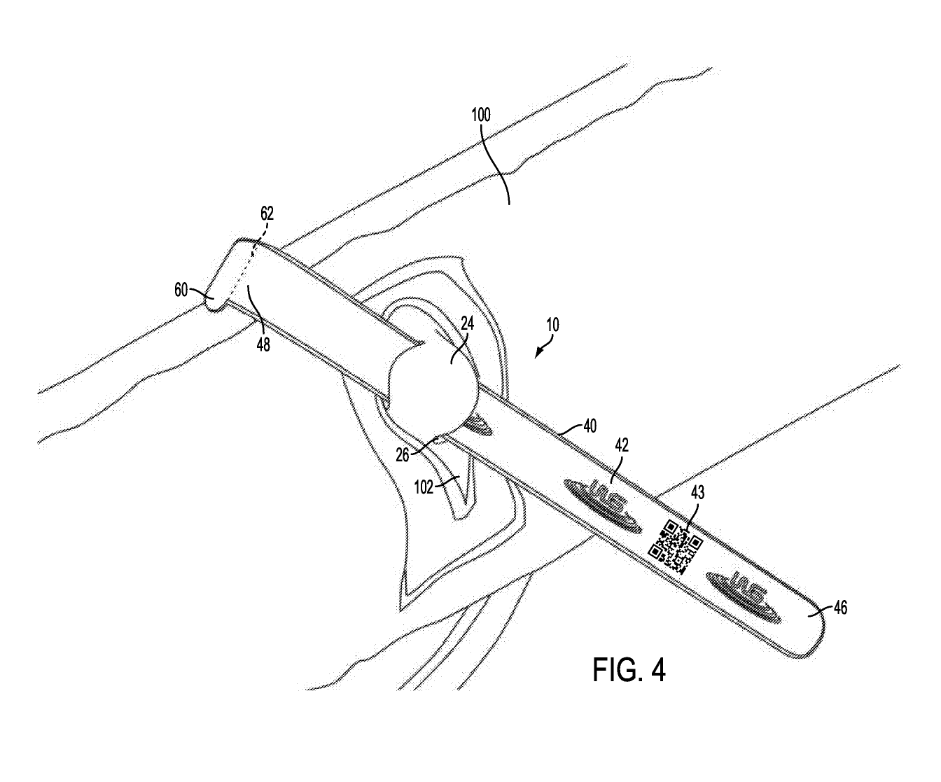

FIG. 3 is a front perspective view of tag 10 applied to object 100, and FIG. 4 is a back perspective view of tag 10 applied to object 100. In the embodiments of FIGS. 3 and 4, object 100 is shown as a garment but could be a shoe or other product, as well. Head 20 of tag 10 is highly visible and prevents the wearing of garment 100 in a public fashion. This prevents a person from wearing a purchased garment, or other product, 100 in public and then returning it. If a person should decide that they want to wear the garment in public and remove tag 10, this can easily be accomplished by pulling tab 60. Break lines 62 formed by a line of perforations along across the width of lanyard 40 to either side of tab 60 facilitate the parting of the segments of lanyard 40. Once tag 10 is removed that particular tag cannot be replaced and its absence serves as a clear indication that the garment has been worn in public. While perforations are shown in the figures, the same effect could be accomplished by reducing the thickness of lanyard 40 at the desired locations. When tag 10 is in position, optical code 23 is positioned to be easily observed. Optical code 23 may be normally visible, or it may require application of ultra-violet light to make optical code 23 visible. Optical code 23 may be a unique identifier for tag 10 or it may be a group identifier, i.e. be a lot identifier for tag 10. Optical 23 prevents the replacement of one-time-use tag 10 with a counterfeit tag.

In FIG. 4, hub 24 may be seen protruding through aperture 102 in object 100. Lanyard 40 is inserted through aperture 26 in hub 24 and is pulled through to maintain tag 10 in position. Attached end 48 of lanyard 40 attaches to tab 60. Again perforation line 62 running across the width of lanyard 40 facilitates the separation of tag 60 from tail 42 or stub 28. Once this separation occurs tag 10 may be removed from the garment. Once the separation is accomplished tag 10 may simply be pushed through the aperture, or tail 42 of lanyard 20 may be pulled all the way through aperture 26 in hub 24 of tag 10. This further facilitates the removal of tag 10 from garment, or object, 100.

In FIG. 4, optical code 43 is placed on the side of lanyard 40 that faces outward when tag 10 is in place. In this position, optical code 43 is more easily referenced. Alternatively, optical code 43 could be placed on the same side of tag 10 as cleats 46 in a position more likely to conceal optical code 43. Optical code 43 on lanyard 40 of tag 10 may be normally visible, or it may require application of ultra-violet light to make optical code 43 visible. Optical code 43 may be a machine readable code such as a bar code or two dimensional code as shown in FIG. 4, or it may be an alphanumeric code.

As previously mentioned in the summary section, tag 10, may also have EAS electronics. Returning to FIG. 2, head 20 comprises EAS electronic components. In the embodiment of FIG. 2, the EAS electronic components comprise passive EAS element 70. EAS element 70 is of the core and coil type of passive element which produces a detectable signal when subjected to an interrogation field produced by a larger EAS system, but other types of passive elements, such as acousto-magnetic labels, could be used. Also, with the current state of miniaturization technology and manufacturing technology, active EAS electronics could also be employed on tag 10. These EAS electronics could be powered by electro-magnetic fields, or onboard power supplies such as batteries, which would power processor chips, communication elements, location other monitoring elements, etc.

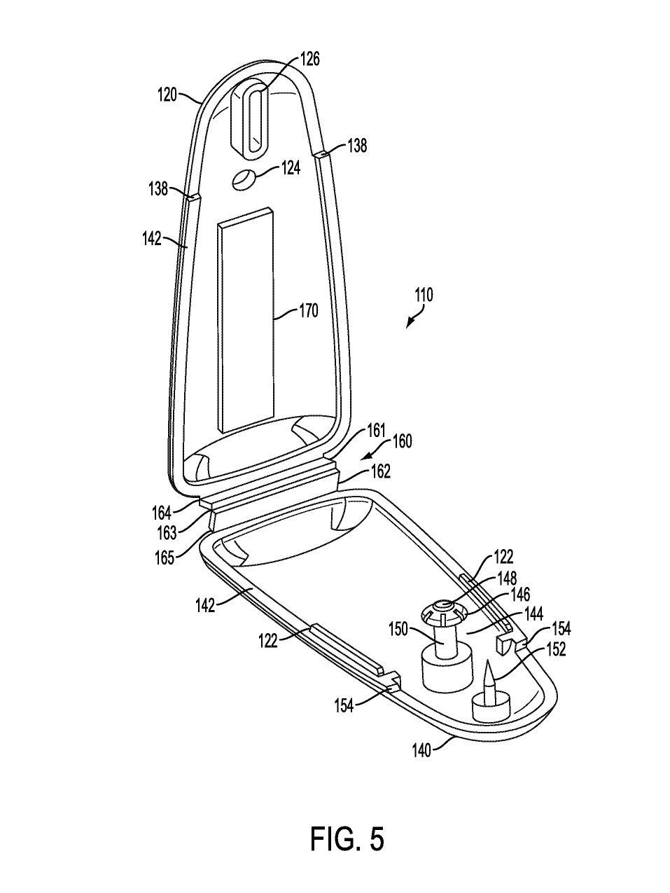

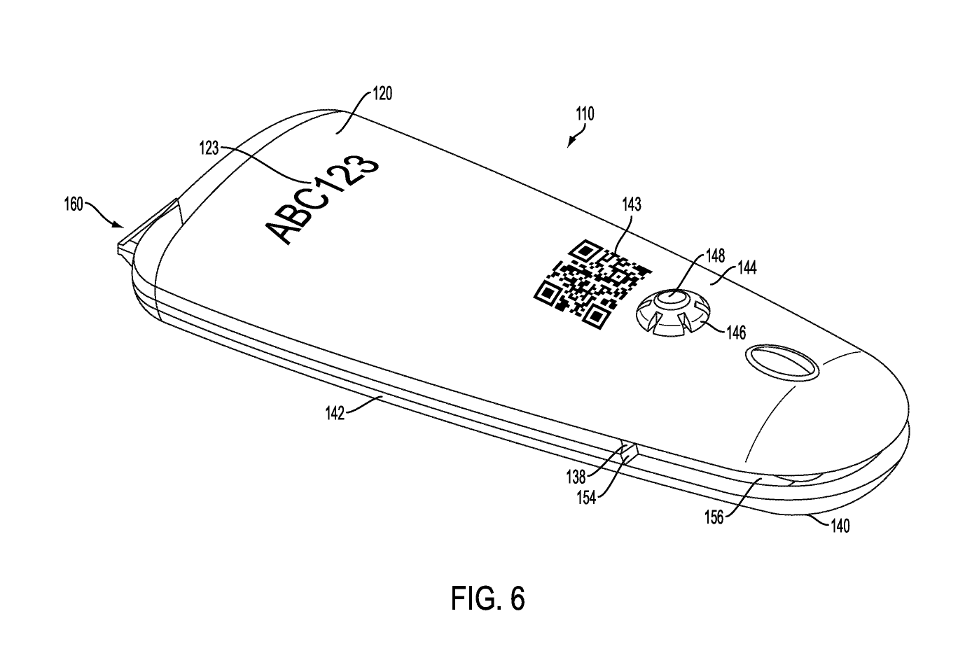

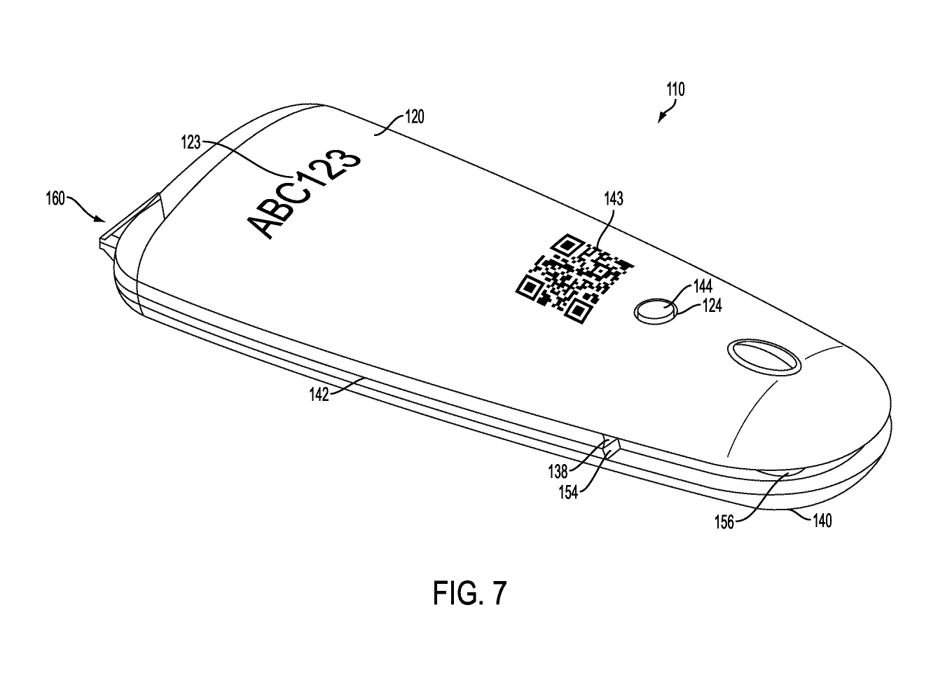

FIG. 5 is a perspective view of an embodiment of a one-time-use hinged tag 110 in an opened configuration. In general, one-time-use tag 110 comprises a top shell 120, a bottom shell 140, and a compound hinge 160 connecting top shell 120 and bottom shell 140. Top 120 and bottom 140 shells are each concave and have edges 142 generally matching each other. Compound hinge 160 is made of two panels, upper panel 161 and lower panel 162. Upper panel 161 and lower panel 162 are connected by central hinge 163 while upper panel 161 is connected to top shell 120 by upper hinge 64 and lower panel 162 is connected to bottom shell 140 by lower hinge 165. When tag 110 is folded at compound hinge 160 to bring top shell 120 together with bottom shell 140, they form a generally hollow body. See FIGS. 6 and 7. Compound hinge 160 bends at central hinge 163, upper hinge 162 and lower hinge 165 to allow upper panel 161 and lower panel 162 to fold into the interior of tag 110.

Tag 110 may have ridges 122 along the interior of edges 142 of top shell 120 or bottom shell 140 which will fit along the interior of edge 142 of its opposite shell. This provides greater rigidity when tag 110 is in the closed configuration. Both top shell 120 and bottom shell 140 have recessed steps 138 and 154 respectively at their ends to create gap 156 (See FIGS. 6 and 7) between their ends when tag 110 is closed. This leaves some space for the material of the garment when tag 110 is closed on a garment.

Post 144 is located within bottom shell 140. Post aperture 124 is located in top shell 120. Post 144 and post aperture 124 are positioned within their respective shells so that when tag 110 is closed post 144 inserts through post aperture 124. Post 144 has at least one catch tab 146 extending from its top 148. In the embodiment shown in FIGS. 5 and 6, post 144 has several catch tabs 146. Catch tabs 146 are flexible and post aperture 124, post 144, and catch tabs 146 are sized so that post 144 can insert through post aperture 124 by the flexing of catch tabs 146 down against the body 150 of post 144. When tag 110 is fully closed and top 148 of post 144 has passed through post aperture 124, catch tabs 146 extend out again. Catch tabs 146 prevent the retraction of post 144 back through post aperture 124 which keeps tag 110 closed (see FIG. 6).

To keep a closed tag 110 attached to a garment, tack 152 is located on the interior of bottom shell 140 and directed toward the concave side of bottom shell 140. Tack aperture 126 on the interior surface of top shell 120 is position to receive tack 152 when tag 110 is closed. When tag 110 is closed on a garment tack 152 passes through the garment and inserts into tack aperture 126. This keeps tag 110 attached to the garment.

Turning now to FIG. 6, FIG. 6 is a perspective view of an embodiment of one-time-use hinged tag 110 in a closed configuration showing top 148 of post 144 inserted through post aperture 124 and catch tabs 146 external to the top shell 120 of tag 110. Catch tabs 146 prevent post 144 from passing back through post aperture 124. To open tag 110 and remove it from a garment, top 148 of post 144 is cut off, including catch tabs 146. This may be accomplished by pressing the ends of top shell 120 and bottom shell 140 together to expose the body 150 of post 144 beneath catch tabs 146 for access by scissors. Alternatively, a single sharp edge could be used and slid under catch tabs 146 to cut body 150 of post 144. Some embodiments of tag 110 may also have excess height in post 144 which would inherently leave body 150 of post 144 exposed.

Optical code 123 on top shell 120 may be an alphanumeric code as shown in FIG. 6, or it may be a machine readable code such as a bar code or a two dimensional code. Optical code 143 may be a machine readable code such as a bar code or two dimensional code as shown in FIG. 6, or it may be an alphanumeric code. It is not necessary that both optical codes 123 and 143 be present on one-time-use tag 110. Rather, they are shown to illustrate options. Among other functions, optical codes 123 and 143 serve to defeat the replacement of a removed single-use tag with a counterfeit tag. Although a thief may be able to obtain a counterfeit tag that sufficiently approximates a retailer's one-time-use tag, without the correct optical code, the replacement tag will not pass closer inspection. Optical codes 123 and 143 may be normally visible, or they may require application of ultraviolet light to make optical codes 123 and 143 visible. Optical codes 123 and 143 may be a unique identifier for one-time-use tag 110 or they may be a group identifier, i.e. be a lot identifier for tag 110. Optical codes 123 and 143 may be placed on one-time-use tag 110 by the several methods discussed with respect to optical codes 23 and 43 and one-time-use tag 10.

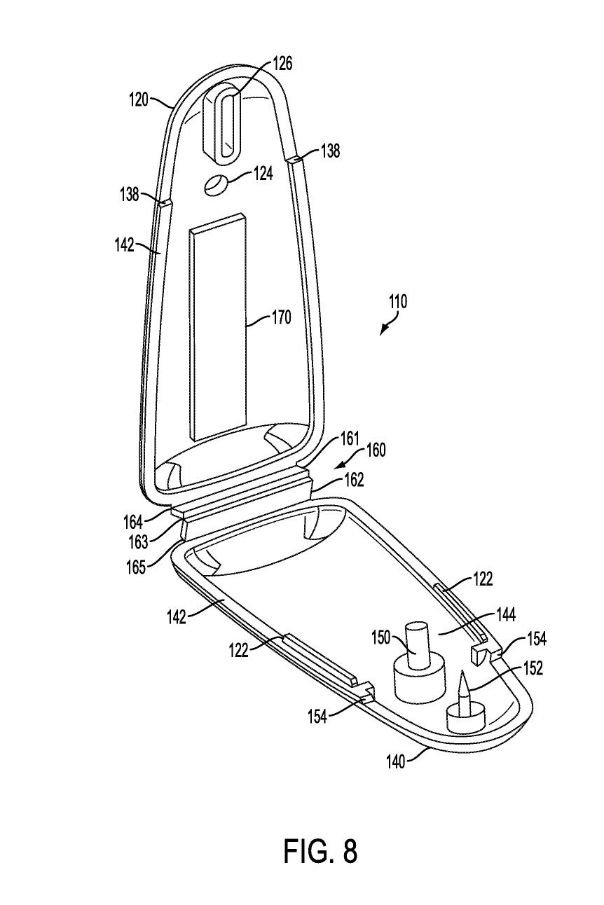

FIG. 7 is the perspective view of FIG. 6 of an embodiment of tag 110 in a closed configuration showing post 144 trimmed and catch tabs 148 removed. With catch tabs 148 removed, the tag 110 can be opened. When tag 110 is opened, tack 152 can be disengaged from the garment, and tag 110 removed. FIG. 8 is the perspective view of FIG. 5 of an embodiment of tag 110 in an opened configuration showing post 144 trimmed and catch tabs 148 removed.

In both FIGS. 5 and 8, EAS element 170 is visible. EAS element 170 is located on the interior surface of top shell 120. EAS element 170 may be passive, semi-passive, or active. Because tag 110 is rendered unusable in the process of removing it, it can only be used once. Because of this, for uses where tag 110 will be removed by the consumer, EAS element 170 will be as inexpensive as practicable. Some embodiments of tag 110 may actually enclose a dummy element which only rattles. For applications where tag 110 will be removed by an authorized person, EAS element 170 may be removably attached to the interior of tag 110. In those applications, the person removing tag 110 could retrieve EAS element 170 for multiple uses.

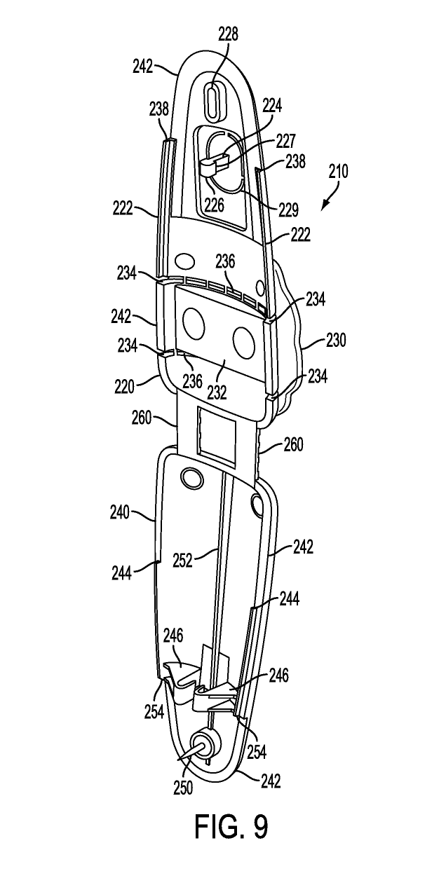

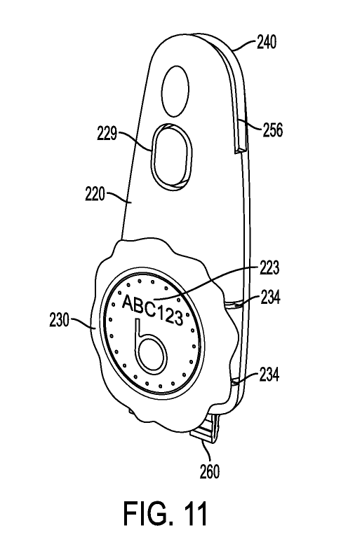

FIG. 9 is a bottom perspective view of an embodiment of a one-time-use hinged tag 210 in open configuration. In the embodiment of FIG. 9, tag 210 comprises a top member 220, a bottom member 240, and a hinge, or hinges, 260 connecting top member 220 and bottom member 240. Top 220 and bottom 240 members are each concave and have edges, or perimeters, 242 generally matching each other. When tag 210 is folded at hinge 260 to bring top member 220 together with bottom member 240, they form a generally hollow body (See FIG. 11). Edges 242 of top member 220 and bottom member 240 may have complimentary ridges 222 and 244. In the embodiment shown in FIG. 9, ridges 222 are outside ridges and ridges 244 are inside ridges. Ridges 222 and 244 overlap each other when tag 210 is closed to provide greater ridgity in the closed configuration. Rib 252 on the interior surface of bottom member 240 provides rigidity in bottom member 240 and to anti-fraud tag 210 when it is in close configuration. Both top member 220 and bottom member 240 have recessed steps 238 and 254 respectively at their ends to create gap 256 (See FIG. 11) between their ends when tag 210 is closed. This leaves some space for the material of the garment.

Opposing hooks 246 are located within bottom member 240. Peg 224 is located within top member 220. Hooks 246 and peg 224 are positioned on the interior surface of their respective members so that when tag 210 is closed, peg 224 inserts in between hooks 246. Peg 224 has an expanded head 226 on it which creates shoulders 227. When peg 224 inserts between hooks 246, hooks 246 latch to shoulders 227 on peg 224 and hold tag 210 in a closed position.

Tack 250 is also located within bottom member 240. Aperture 228 is also within top member 220. When tag 210 is closed, tack 250 passes through the garment to which tag 210 is attached and inserts into aperture 228. This keeps tag 210 attached to the garment. In the embodiment shown in FIG. 9, aperture 228 is elongated.

Top member 220 has a continuous series of perforations 229 through it around the base of peg 224. To remove tag 210 from a garment, the buyer pulls top member 220 and bottom member 240 apart at the ends with enough force to tear perforations 229 about peg. This parts peg 224 from the rest of top member 220 which allows tag 210 to be fully opened, removing tack 250 from the garment, which allows the removal of tag 210 from the garment. This also prevents the forced separation of the holding elements while the tag stays intact. Perforations 220 in top member 220 cause the peg 224 to break away and part from top member 220 before the holding elements peg 224 and hooks 246 disengage.

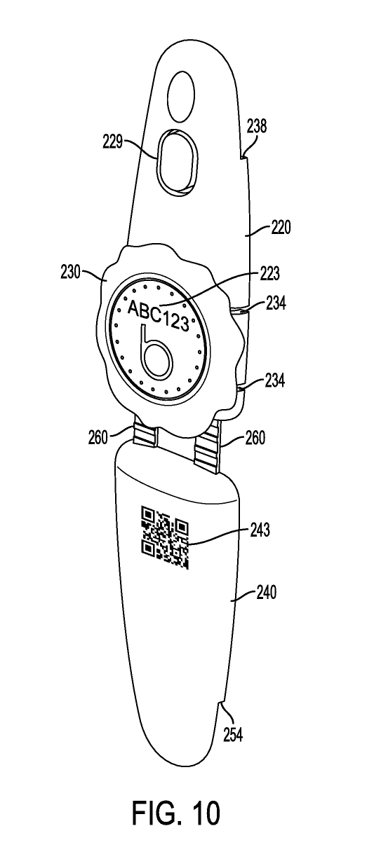

Turning now to FIG. 10, FIG. 10 is a top perspective view of tag 210 in an open configuration. This view shows the surfaces that will be the external surfaces of tag 210 in its closed configuration. Medallion 230 is located on the top of top member 220 of tag 210. The edge of Medallion 230 extends from top member 220, presenting a tab. Returning to FIG. 9, panel 232 may be seen on the bottom of top member 220. Medallion 230 and panel 232 are joined together. Notches 234 at the edges 242 of top member 220 align generally with panel 232 and medallion 230. Referencing FIG. 9, perforations 236 extend through top member 220 in general alignment with notches 234 and extend across top member 220 in vicinity of panel 232 and medallion 230. Notches 234 may also be seen in FIGS. 9 and 11. Perforations 229 around peg 224 can also be seen in FIGS. 9 and 11.

Optical code 223 on top member 220 may be an alphanumeric code as shown in FIG. 10 (and FIG. 11), or it may be a machine readable code such as a bar code or a two dimensional code. Optical code 243 on bottom member 240 may be a machine readable code such as a bar code or two dimensional code as shown in FIG. 10, or it may be an alphanumeric code. It is not necessary that both optical codes 223 and 243 be present on one-time-use tag 210. Rather, they are shown to illustrate options. Among other functions, optical codes 223 and 243 serve to defeat the replacement of a removed single-use tag with a counterfeit tag. Although a thief may be able to obtain a counterfeit tag that sufficiently approximates a retailer's one-time-use tag, without the correct optical code, the replacement tag will not pass closer inspection. Optical codes 223 and 243 may be normally visible, or they may require application of ultraviolet light to make optical codes 223 and 243 visible. Optical codes 223 and 243 may be a unique identifier for one-time-use tag 210 or they may be a group identifier, i.e. be a lot identifier for tag 210. Optical codes 223 and 243 may be placed on one-time-use tag 210 by the several methods discussed with respect to optical codes 23 and 43 and one-time-use tag 10.

In use, tag 210 is closed upon an object, such as a garment, and tack 250 passes through the garment, or object, and into aperture 228. Peg 224 fits into hooks 246 which latch onto shoulders 226 on peg 224 to hold tag 210 in the closed position attached to the garment. A buyer purchases the garment and takes it home. When the buyer decides to keep and wear the garment, the buyer may remove the tag. In the embodiment shown in FIGS. 9-11, removal of the tag is accomplished by breaking perforations 229 around peg 224 or perforations 236 across the width of top member 220 and parting one-time-use tag 210.

Breaking the set of perforations 236 along medallion 230 is facilitated by pulling or turning medallion 230. Notches 234 and perforations 236 in top member 220 allow the pulling or turning of medallion 230 to separate top member 220 into pieces. Once top member 220 is parted, peg 224 can be removed from hooks 246 which allows tag 210 to be removed from the garment.

Alternatively, a buyer can break perforations 229 around peg 224. To do this, a buyer pull or pries apart the ends of top member 220 and bottom member 240. When perforations 229 around peg 224 are broken, tag 210 can be opened, which withdraws tack 250 from the garment, allowing tag 210 to be removed. This also prevents tag 210 from being removed from the garment intact, in which case it could be reattached.

Once one-time-use tag 210 is removed by destroying it, it cannot be reattached to the garment by the purchaser. The absence of tag 210 allows a retailer to assume that the garment, or item, has been worn, or used, and the retailer can act with return policies conceived for those situations. The presence of optical code 223 or 243 prevents the installation of a counterfeit tag to deceive the retailer into believing the item has not been worn, or used.

When a retailer uses any of the several embodiments of one-time-use tags having an optical code, it is much more difficult for a thief to employ a counterfeit tag. When the optical code requires the presence of ultraviolet light to observe the code, this difficulty is increased. Further, when the optical code of a one-time-use tag on an item is recorded in association with the purchase of that item, the optical code then provides a separate confirmation code in addition to the inventory ID of the purchased item. The combination of two distinct identifiers increases the effort required to effectively reproduce the combination of numbers in order to return an item. When the optical code is machine readable, the recordation of the optical code at purchase of the item can be automated.

It is to be understood that the embodiments and arrangements set forth herein are not limited in their application to the details of construction and arrangement of the components set forth in the description and illustrated in the drawings. Rather, the description and the drawings provide examples of the embodiments envisioned, but the invention is not limited to the specific embodiments. The embodiments disclosed herein are further capable of other embodiments and of being practiced and carried out in various ways, including various combinations and sub-combinations that may not have been explicitly disclosed. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the invention be regarded as including such equivalent constructions.

I claim:

1. A one-time-use tag for the prevention of fraudulent return of a product, said tag comprising:
a tag body comprising a set of complimentary attaching elements for attaching the one-time-use tag to an item for retail sale; and,
an optical code on an external surface of the one-time-use tag; wherein,
when said complimentary attaching elements are engaged to attach the one-time-use tag to an item for retail sale, the complimentary attaching elements cannot be disengaged without at least partially destroying the one-time-use tag and rendering the one-time-use tag unable to be used again.

2. The one-time-use tag of claim 1, wherein:
said complimentary attaching elements comprise an aperture in said tag body and a lanyard extending from said tag body, said lanyard comprising a series of cleats, said cleats and aperture allowing said lanyard to be inserted through said aperture but not allowing said lanyard to be withdrawn backward through said aperture.

3. The one-time-use tag of claim 2, wherein:
said lanyard is parted to remove the one-time-use tag from an item to which the single use tag has been attached.

4. The one-time-use tag of claim 1, wherein:
the one-time-use tag comprises a hinge, said hinge dividing the one-time-use tag into two parts, each said part comprising one of said complimentary attaching elements, said complimentary attaching elements aligning and connecting with each other when the one-time-use tag is folded at said hinge.

5. The one-time-use tag of claim 4, further comprising:
an aperture in one of said parts and a tack in the other of said parts, said tack inserting into said aperture when the one-time-use tag is folded at said hinge.

6. The one-time-use tag of claim 4, wherein:
said hinge is parted to remove the one-time-use tag from an item to which the single use tag has been attached.

7. The one-time-use tag of claim 4, wherein:
one of said parts comprises a series of perforations across its width, this one of said parts being parted along said perforations to remove the one-time-use tag from an item to which the one-time-use tag has been attached.

8. The one-time-use tag of claim 4, wherein:
one of said parts comprises a series of perforations around its respective complimentary attaching element, said one of said parts being parted at said apertures to separate its respective complementary attaching element to remove the one-time-use tag from an item to which the one-time-use tag has been attached.

9. The one-time-use tag of claim 4, wherein:
one of said complimentary attaching elements comprises an aperture, and the other of said complimentary attaching elements comprises a post with a head, said head of said post configured to be able to be inserted into said aperture but not withdrawn from said aperture without at least partially destroying said post.

10. The one-time-use tag of claim 1, wherein:
said optical code is an alphanumeric code.

11. The one-time-use tag of claim 1, wherein:
said optical code is a machine readable code.

12. The one-time-use tag of claim 11, wherein:
said machine readable code is one of
a bar code, or
a two dimensional code.

13. The one-time-use tag of claim 1, wherein:
said optical code is ultraviolet light reactive.

14. The one-time-use tag of claim 1, wherein:
said optical code is printed on the one-time-use tag.

15. The one-time-use tag of claim 1, wherein:
said optical code is formed in the surface of the one-time-use tag.

16. The one-time-use tag of claim 1, wherein:
said optical code is a unique identifier for each one-time-use tag.

17. The one-time-use tag of claim 1, wherein:
said optical code is a chronological indicator.

18. The one-time-use tag of claim 1, further comprising:
electronic article surveillance electronics.

19. A method of preventing theft by the fraudulent return of retail items, said method comprising;
attaching to a retail item a one-time-use tag having an optical code, said tag being removable only by at least partially destroying said tag and rendering said tag un-reusable;
recording said optical code of said tag at the time of sale of the retail item; and,
executing a predetermined return policy if an attempt is made to return the retail item without said tag being attached.

20. The method of preventing theft by the fraudulent return of retail items of claim 19, wherein;
said optical code is ultraviolet reactive and made visible by illumination with an ultraviolet light.
